(19) United States
(12) Patent Application Publication
(10) Pub. No.: US 2012/0057878 A1
(43) Pub. Date: Mar. 8, 2012

(54) COMMUNICATION DEVICE AND CONTROL METHOD OF THE SAME

(76) Inventors: ATSUSHI KOZATO, Tokyo (JP); Yota Ito, Tokyo (JP)

(21) Appl. No.: 13/223,796

(22) Filed: Sep. 1, 2011

(30) Foreign Application Priority Data
Sep. 7, 2010 (JP) 199880/2010

(51) Int. Cl. H04B 10/04; H04B 10/24

(52) U.S. Cl. 398/135; 398/183

(57) ABSTRACT

Disclosed is an optical communication device, including: a light source that outputs an optical signal; a modulation unit that modulates transmission data and inputs it to the light source; a storage unit that holds a set value of the light source or the modulation unit; a power consumption adjustment unit that, according to an instruction, acquires the set value from the storage unit, optimizes power consumption within a predetermined range of transmission characteristics, and determines a set value; and a control unit, being provided the determined set value, that controls power consumption of at least one of the light source and the modulation unit based on the provided set value.

This application is based upon and claims the benefit of priority from Japanese Patent Application No. 2010-199880, filed on Sep. 7, 2010, the disclosure of which is incorporated herein in its entirety by reference.

### TECHNICAL FIELD

The present invention relates to a communication device and a control method thereof, and, particularly, to a method for controlling power consumption in an optical communication device used for a network communication and an optical communication device, in which power consumption is controlled.

### BACKGROUND ART

In recent years, an increase of power consumption in network devices according to increased traffic and enhancement of communication rates has become a serious problem. Due to the increase of the power consumption, power supply equipments become large, and cooling facilities for cooling generated heat have become indispensable. For this reason, the increase of power consumption is one of factors of raising a cost for operating the network devices.

Therefore, suppression of the power consumption of the network device becomes increasingly important.

Japanese Patent Application Laid-Open No. 2007-214731 discloses a communication device, which detects a notification on an operation state supplied from another communication device, which is a communication counterpart. The communication device, based on the information indicating the operation state, controls an operation state of an interface, signal output and activation of the interface.

FIG. 5 is a block diagram showing a configuration of a network interface 1011 disclosed in Japanese Patent Application Laid-Open No. 2007-214731. A light signal transmitted through an optical cable is received by an optical signal waveform conversion unit for reception (PMD-RX) 1024. A status control unit 1061 controls an operation state of each unit of the network interface 1011, based on an instruction from a host 1012 or on a state of another communication device connected to the network interface 1011. That is, a PS (power save) manager 1071, incorporated in the status control unit 1061, includes a state machine for controlling power management. The PS manager outputs electric power control state information, indicating the current state of the state machine, thereby controlling an operation of a MAC 1031 and a PSC 1032 in an interface unit 1022, and of a link pulse generation unit 1073. Further, the PS manager 1071 outputs a wake-up signal for activating a host 1012 in a sleep state. The PS manager 1071, when acquiring reception link pulse status information from a link pulse detection unit 1072, updates the current state of the state machine.

Further, Japanese Patent Application Laid-Open No. 2003-224326 discloses an optical transmitter module, which stores parameters (electric current value, temperature, intensity or the like) optimized for an output value (intensity, wavelength, or the like) of an optical signal to be outputted, and generates an optical signal with an instructed output value at the time of operation.

FIG. 6 is a block diagram showing a configuration of an optical transmitter module 2011 disclosed in Japanese Patent Application Laid-Open No. 2003-224326. The optical transmitter module 2011 is provided with an LD (laser diode) control LSI 2012. Optical output from an LD module 2002 is modulated by a LD-Dry (LD modulation driver) 2016 into a light signal, and is outputted.

A data inputted from outside is converted by a serial parallel converting circuit 2015 into a parallel data, and stored in a register 2014. The stored data is further converted by a DAC (digital-to-analog converter) 2013 into an input voltage to each circuit.

A light signal to be outputted based on the input voltage is automatically controlled by an ATC (automatic temperature control) circuit 2003, an APC (automatic optical power control) circuit 2004 and an ACC (automatic current control) circuit 2005, so as to maintain an optical output value, which has been once set, at a constant value regardless of a change in a communication environment. Parameters necessary for changing the optical output value are held in the register 2014. In order to acquire the parameters, an automatic adjustment system, to which a measuring device and an arithmetic unit are connected, is configured in the optical transmitter module 2011. That is, parameters in each circuit are adjusted, and obtained values as a result of adjusting are written in the register.

### SUMMARY

An object of the present invention is to provide a communication device and a control method thereof that reduce power consumption without a problem in use.

An optical communication device, according to an exemplary aspect of the invention, includes: a light source that outputs an optical signal; a modulation unit that modulates transmission data and inputs the modulated transmission data to the light source; a storage unit that holds a set value of the light source or the modulation unit; a power consumption adjustment unit that, according to an instruction, acquires the set value from the storage unit, optimizes power consumption within a predetermined range of transmission characteristics, and determines a set value; and a control unit, being provided the set value determined by the power consumption adjustment unit, that controls power consumption of at least one of the light source and the modulation unit based on the provided set value.

A control method for controlling power consumption of an optical communication device, the optical communication device outputting an optical signal based on transmission data, according to an exemplary aspect of the invention, the method includes steps of: optimizing power consumption, according to an instruction, within a predetermined range of transmission characteristics and determining a set value for at least one of modulation of the transmission data and output of the optical signal; modulating the transmission data according to the set value; and outputting the optical signal according to the set value.

A transmission apparatus for outputting an optical signal to a network based on transmission data transmitted from a host apparatus, according to an exemplary aspect of the invention, includes: an instruction unit that transmits an instruction; and an optical communication device. The optical communication device includes: a light source that outputs an optical signal; a modulation unit that modulates the transmission data and inputs the modulated transmission data to the light source; a storage unit that holds a set value of the light source or the modulation unit; a power consumption adjustment unit that, according to the instruction transmitted from the instruction unit, acquires the set value from the storage unit, optimizes power consumption within a predetermined range of transmission characteristics, and determines a set value; and a control unit, being provided the set value determined by the power consumption adjustment unit, that controls power consumption of at least one of the light source and the modulation unit based on the provided set value.

A recording medium storing a program causing a computer to execute control processing for controlling power consumption of an optical communication device outputting an optical signal based on transmission data, according to an exemplary aspect of the invention, the processing includes: a step of optimizing power consumption, according to an instruction, within a predetermined range of transmission characteristics and determining a set value of at least one of modulating the transmission data and outputting the optical signal; a step of modulating the transmission data according to the set value; and a step of outputting the optical signal according to the set value.

### BRIEF DESCRIPTION OF DRAWINGS

Exemplary features and advantages of the present invention will become apparent from the following detailed description when taken with the accompanying drawings in which:

FIG. 1 is a block diagram showing a configuration according to a first exemplary embodiment of the present invention;

FIG. 2 is a flow chart showing an operation according to the first exemplary embodiment of the present invention;

FIG. 3 is a block diagram showing a configuration according to a second exemplary embodiment of the present invention;

FIG. 4 is a flow chart showing an operation according to the second exemplary embodiment of the present invention;

FIG. 5 is a diagram illustrating a related art; and.

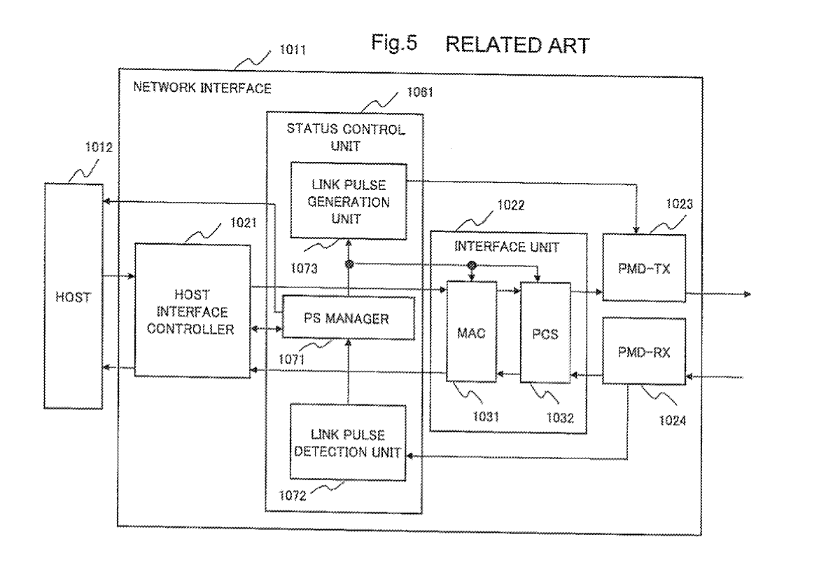

FIG. 6 is a diagram illustrating the related art.

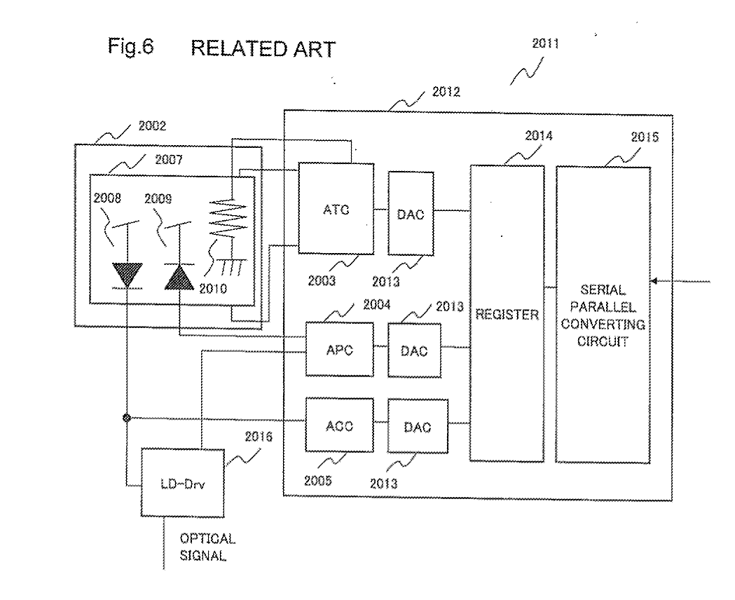

### EXEMPLARY EMBODIMENT

### First Exemplary Embodiment

Next, an embodiment for carrying out the present invention will be described in detail with reference to the drawings.

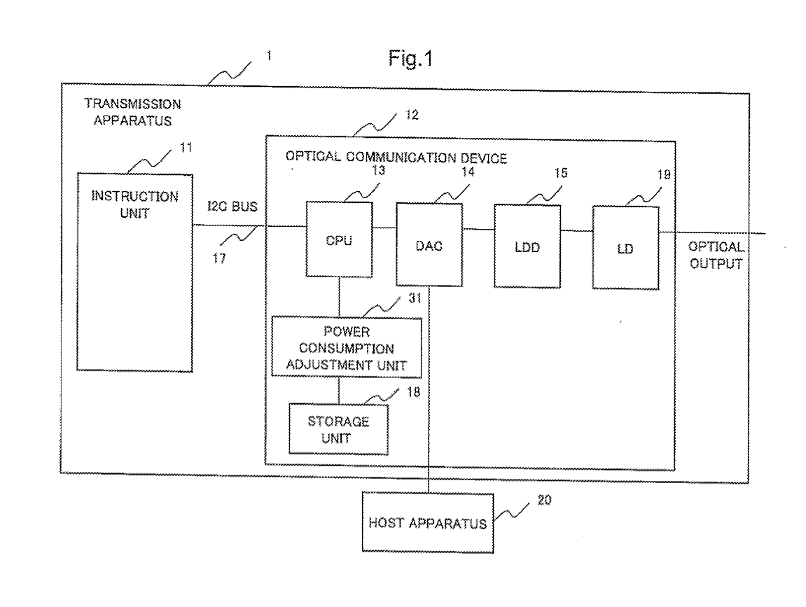

FIG. 1 is a block diagram showing an example of a configuration of a transmission apparatus according to the first exemplary embodiment of the present invention.

A transmission apparatus 1 includes an optical communication device 12 and an instruction unit 11 connected to the optical communication device 12 via an I2C (Inter Integrated Circuit) bus 17. The optical communication device 12 modulates a signal from a host apparatus 20, according to a standard e.g. XFP (10 (X) Gigabit Small Form Factor Pluggable) or the like, into an optical signal, and transmits the signal. Meanwhile, the present embodiment is not limited to the standard of XFP and is also applied to a standard, such as SFP (Small Form Factor Pluggable) or XENPAK (10 (X) Gigabit EtherNet transceiver Package).

The optical communication device 12 includes a digital-to-analog converter (DAC) 14, a laser diode (LD) 19 and a laser diode driver (LDD) 15. The optical communication device 12 modulates a digital signal into an optical signal and outputs the optical signal as optical output.

Values of an optical signal output, a drive current of the LDD 15, a bias current of the LD 19 and a setting temperature and the like are provided to the DAC 14. In a central processing unit (CPU) 13 (a control unit) connected to the DAC 14, these values are set by a power consumption adjustment unit 31 connected to the CPU 13.

These set values are stored in a storage unit 18 connected to the CPU 13. The set values are read from the storage unit 18 and are adjusted by the power consumption adjustment unit 31 as necessary. The values, determined as a result of the adjustment, are given to the CPU 13.

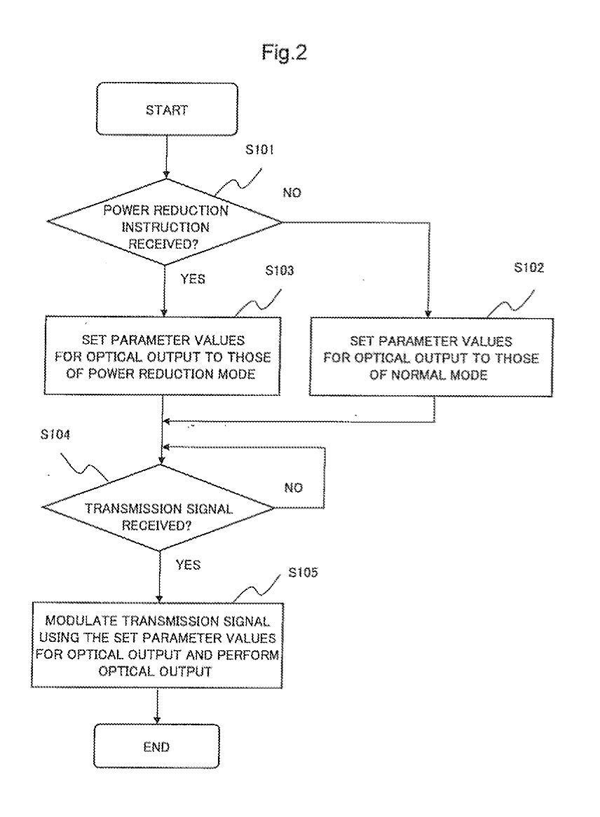

Next, an example of operation of an optical communication device according to the first exemplary embodiment of the present invention will be described with reference to FIGS. 1 and 2.

When transmitting an optical signal with reduced electric power, the instruction unit 11 sends an instruction via the I2C bus 17 to the optical communication device 12 to reduce the power. When the CPU 13 receives the power reduction instruction (S101 YES in FIG. 2), the power consumption adjustment unit 31 reads: a value of the parameter required for modulating a transmission signal into an optical signal of a power reduction mode in the DAC 14; a value of the parameter required for driving the LD 19 in the LDD 15; and a value of the parameter required for operating the LD 19 (hereinafter, referred to as parameter values for optical output), from the storage unit 18. The power consumption adjustment unit 31 performs setting based on the read values (S103). When a power reduction instruction is not received from the instruction unit 11, the CPU 13 reads parameter values for optical output in a normal mode from the storage unit 18, to perform setting. Meanwhile, in FIG. 2, the step of S101 may include a processing, in which the instruction unit 11 changes the setting so as to output the optical signal in the normal mode, in the state where the DAC 14 modulates a signal based on the parameter values for modulating in the power reduction mode. In this case, Step S101 is read as “receiving an instruction to change to the normal mode”, and the indicators YES and NO are exchanged.

The power consumption adjustment unit 31 determines parameter values for optical output so as to optimize the power consumption of the optical communication device 12 and so as not to cause a problem in actual use. For example, an intensity of the optical output from the LD 19 is reduced so that the wavelength of the optical output stays within the region for the signal detection in optical communication processing. A value of the drive current may be reduced, while a controlling temperature control unit (not shown) so that the operating temperature of the LDD 15 is lower than a predetermined temperature.

That is, in the first exemplary embodiment, the power consumption of the optical communication device 12 is optimized under the restriction that the transmission characteristics of optical output are within a predetermined range. Meanwhile, this predetermined range of the transmission characteristics, described as above, may be defined according to at least one of the wavelength of the optical output; the intensity of the optical output and the operating temperature of the LDD. Also, the predetermined range may be defined taking account of the transmission rate or the error rate of the signal transmitted by the optical output. The transmission loss of the transmission line may be taken into account.

When the parameter value required for the modulation in the DAC 14 is set, the optical communication device 12 waits for a transmission signal from the host apparatus 20. The DAC 14 receives a transmission signal (S104 YES), modulates the transmission signal from the host apparatus 20 based on the set parameter value for the modulation and outputs the modulated signal to the LDD 15. Then, the parameter values for the optical output set in the CPU 13 are handed to the LDD 15. The LDD 15 drives the LD 19 based on the parameter values for the optical output, to output an optical signal (S105).

The parameter values for the optical output in the power reduction mode and in the normal mode are held in the storage unit 18 in advance. The parameter value for the optical output in the normal mode may be a value, which is set so as to optimize the transmission characteristics of optical signal, as in the modulation into an optical signal and the optical output in the optical communication apparatus in conformity with the related standard of XFP. The parameter value for the optical output in the power reduction mode is the value determined so as to optimize the power consumption according to a network environment, to which the transmission apparatus 1 is connected. That is, the parameter values minimize the power consumption, while an occurrence of a problem in the signal transmission under the network environment being prevented, e.g. the transmission error rate is smaller than an acceptable value.

These parameter values may be obtained by adjusting while observing a characteristic value in the transmission apparatus 1 connected to the network. Furthermore, the parameter values may be estimated based on a characteristic value characterizing the network to which the transmission apparatus 1 is connected.

Meanwhile, in FIG. 2, the transmission signal is modulated and the optical signal is outputted after the parameter values for the optical output are set, the exemplary embodiment is not limited to this. The setting of the parameter values for the optical output may be after the modulation and the optical output for a part of the transmission signal, in such a case where the transmission signal is intermittently transmitted as an optical signal.

For example, when the optical output from the LD19 is reduced in half, the electric power consumed in the LD 19 becomes approximately a half. A single mode optical fiber (SMF) in common use has characteristics where an optical transmission loss is about 0.2 dB/km. Then, the transmission distance of the outputted optical signal becomes shorter by about 15 km. In other words, when the optical output has a margin of 15 km or more in transmission distance, even if the power consumption of the LD 19 is reduced in half, a problem in the signal transmission will not occur.

The optical communication device in conformity with the XFP standard operates so as to prioritize the optical transmission characteristics. However, the optical communication device of the XFP standard will not operate so as to optimize the power consumption. The optical transmission characteristics in conformity with XFP are designed and adjusted such that sufficient characteristics will be secured even under an environment where the transmission distance or the like is close to the standard limit. Accordingly, when this optical communication device operates under an environment where a sufficiently large margin for the standard limit in the optical transmission characteristics is secured, even if the parameter values are set so as to optimize the power consumption, a problem will not occur practically. On this occasion, the LDD 15 operates with a lower drive current than normal, and the LD 19 operates in a state that optical characteristics are degraded. In this state of the optical output, compared with the normal characteristics, the optical output is weak, and the eye pattern is deteriorated or the jitter increases according to the low LD bias current. However, the optical communication device operates with the characteristic degradation to a degree where a serious damage in the transmission characteristics will not occur. That is, the optical communication device according to the first exemplary embodiment can operate with a minimum power consumption required for optical signal transmission, and the consumption of electric power, which would be excessive in the optical communication device in the related art, is reduced.

### The Second Exemplary Embodiment

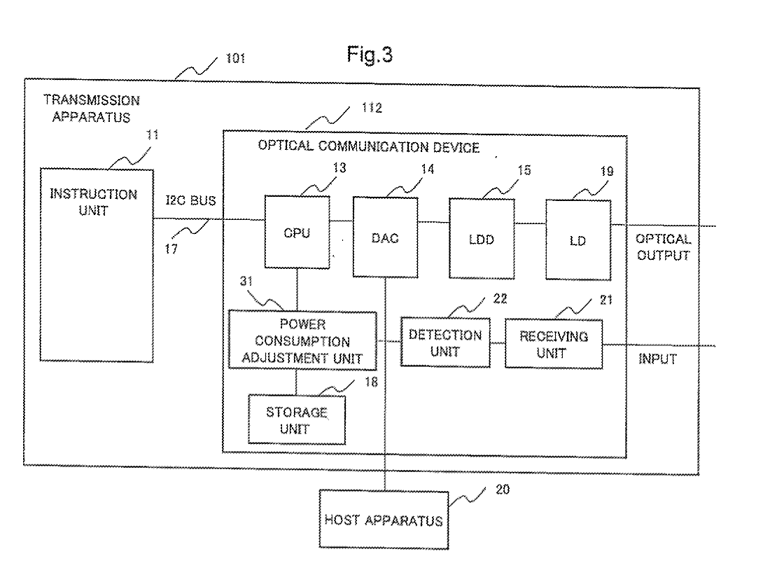

FIG. 3 is a block diagram showing an example of the structure of a transmission apparatus according to the second exemplary embodiment of the present invention.

A transmission apparatus 101 according to the second exemplary embodiment includes an optical communication device 112 formed by adding, to the optical communication device 12 in the transmission apparatus 1 according to the first exemplary embodiment, a receiving unit 21 for receiving a signal inputted from a network, and a detection unit 22 for monitoring an optical output based on a result of analysis by the receiving unit 21. Description of members overlapping with those in the transmission apparatus 1 according to the first exemplary embodiment will be omitted.

Because an environment of the network, to which the transmission apparatus 101 is connected, varies temporally, it is necessary to change the parameter values for the optical output of the power reduction mode, which are set so as to optimize the power consumption, according to the variation in the network environment.

A part of signals transmitted to the network is inputted to the detection unit 22, and data used for monitoring a network state is detected. A signal inputted to the detection unit 22 via the receiving unit 21 may be an optical output emitted from the transmission apparatus 101 or may be an optical signal sent from other transmission apparatus or the like. Furthermore, a unit (not shown) that detects a value characteristic to an optical communication network may be provided in the network.

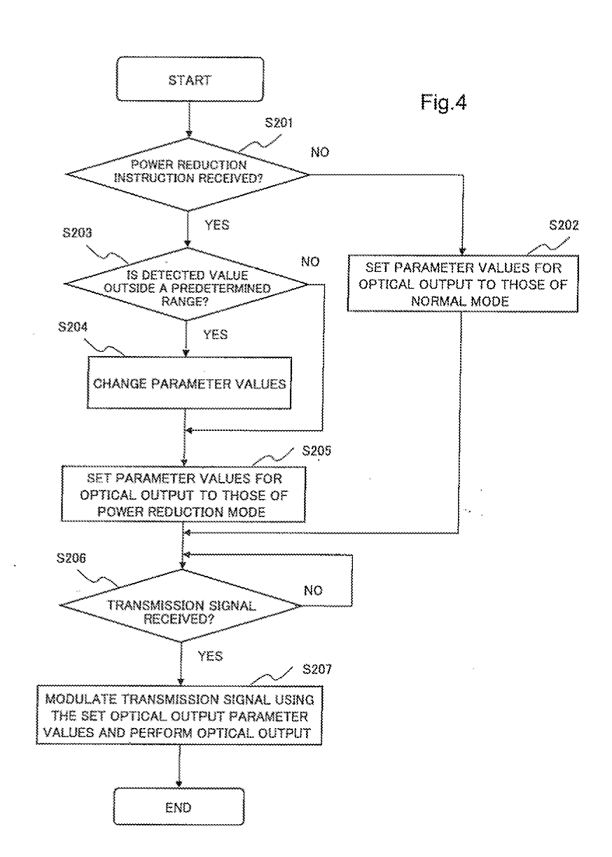

Next, operation of an optical communication device according to the exemplary embodiment of the present invention will be described with reference to FIGS. 3 and 4. Meanwhile, description of operation overlapping with the first exemplary embodiment will be omitted.

In a power consumption control method according to the second exemplary embodiment, when a detected value acquired by the detection unit 22 deviates from a predetermined range, a parameter values for optical output is required to be changed since the network environment has changed. For example, an increase of an optical transmission loss, an interference with other signals in the network or the like may cause an increase of an error rate of the optical signals. Alternatively, depending on the condition, there may be a case where a communication environment improves, thereby the power consumption being lowered. The detection unit 22 outputs the detected value to the power consumption adjustment unit 31. The power consumption adjustment unit 31 confirms whether the detected value is within the predetermined range or not. When the detected value is within the predetermined range (S203 NO), the parameter values for optical output in the power reduction mode stored in the storage unit 18 are read out, and setting is performed based on the parameter values. On the other hand, when the detected value deviates from the predetermined range (S203, YES), the parameter values of optical output are changed so as to optimize the power consumption within a range where a problem would not occur in the signal transmission (S204). The parameter values changed as above may be stored in the storage unit 18. Meanwhile, for acquiring the changed parameter values, changed values in a correspondence table previously provided in the storage unit 18 may be referred to based on the detected value, or changed values may be estimated from the detected value based on hypothesis. Or, the power reduction mode may be switched to the normal mode.

Furthermore, during the operation in the normal mode, when the detected value by the detection unit 22 deviates from the predetermined range, it is considered that a transmission failure has occurred in a network. In this case, in order to maintain the communication path, the parameter values for optical output may be changed so as to increase the power of the optical signal outputted from the LD 19.

Meanwhile, in FIG. 4, the processing for the modulation and the optical output for the transmission signal is carried out after determining the parameter values for optical output, but the present invention is not limited to this. That is, when the transmission signal is transmitted intermittently as an optical output, for example, the parameter values for optical output may be determined after modulation and optical output for a part of the transmission signals.

According to the second exemplary embodiment, in a case where the communication environment has deteriorated due to a change in the state of the network, to which the transmission apparatus 101 is connected, the setting is reconfigured by changing the parameter values for optical output, so that a problem in use may not occur. When the communication environment has improved, to have surplus in power consumption, the power consumption is reduced by lowering the optical output.

In the related arts, there may be a case where the stability of the network environment is not guaranteed only by lowering the output power and the duty ratio in order to suppress the power consumption. The simple lowering the output power, as above, may cause a problem in use of the network device. In recent years, stability in the network environment is one of the strongest demands for the communication system.

A network communication apparatus disclosed in Japanese Patent Application Laid-Open No. 2007-214731 detects an operation state of a communication counterpart, and changes an operation of the communication apparatus based on the detection result. Accordingly, if status information of the communication counterpart is not provided, a problem in communication may occur. That is, the communication apparatus cannot receive a signal from the communication counterpart, when the state of the communication partner is not detected.

An optical transmitter module disclosed in Japanese Patent Application Laid-Open No. 2003-224326 transmits a signal using the wavelength division multiplexing (WDM). That is, an optical transmitter module disclosed in Japanese Patent Application Laid-Open No. 2003-224326 transmits a signal, in which a plurality of carriers with different wavelengths are multiplexed so that the wavelengths may not be influenced by the signal output. However, when the drive current value is controlled so as to automatically provide the most suitable values corresponding to the instructed output value, that is, so as to reduce the power consumption, the wavelengths may change and interference between signals may occur, thereby causing a problem in communication. Accordingly, the configuration of Japanese Patent Application Laid-Open No. 2003-224326 cannot be applied for reducing the power consumption.

According to the present invention, in an optical communication device used for network communication, power consumption is controlled in a manner that transmission characteristics do not deviate from a predetermined range, and thus power consumption of the optical communication device is reduced without causing a problem in communication.

In a transmission apparatus, a router, a switch and a server in which low power consumption is required, the present invention can be applied for suppressing the power consumption while maintaining the communication environment.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

1. An optical communication device, comprising:
a light source that outputs an optical signal;
a modulation unit that modulates transmission data and inputs said modulated transmission data to said light source;
a storage unit that holds a set value of said light source or said modulation unit;
a power consumption adjustment unit that, according to an instruction, acquires said set value from said storage unit, optimizes power consumption within a predetermined range of transmission characteristics, and determines a set value; and
a control unit, being provided said set value determined by said power consumption adjustment unit, that controls power consumption of at least one of said light source and said modulation unit based on said provided set value.

2. The optical communication device according to claim 1, wherein
said predetermined range of transmission characteristics is determined by at least one of a transmission rate, an error rate, a strength, a wavelength and a transmission loss of said optical signal.

3. The optical communication device according to claim 1, wherein
said instruction includes a first instruction for instructing reduction of power consumption.

4. The optical communication device according to claim 3, wherein
a set value determined according to said first instruction includes a value determined so that a problem does not occur in transmission of said transmission data in a network, said light source being connected to said network.

5. The optical communication device according to claim 1, further comprising:
a detection unit that detects data received from said network, said light source being connected to said network, wherein
the control unit controls the power consumption of at least one of said light source and said modulation unit based on said detected data.

6. The optical communication device according to claim 5, wherein
said control unit stores said set value determined based on said detected data in said storage unit.

7. The optical communication device according to claim 5, wherein,
when the power consumption of at least one of said light source and said modulation unit, can be reduced, said control unit determines said set value based on said detected data so that the power consumption of at least one of said light source and said modulation unit is reduced.

8. A control method for controlling power consumption of an optical communication device, said optical communication device outputting an optical signal based on transmission data, said method comprising steps of:
optimizing power consumption, according to an instruction, within a predetermined range of transmission characteristics and determining a set value for at least one of modulation of said transmission data and output of said optical signal;
modulating said transmission data according to said set value; and
outputting said optical signal according to said set value.

9. The control method according to claim 8, wherein
said predetermined range of transmission characteristics is determined by at least one of a transmission rate, an error rate, a strength, a wavelength and a transmission loss of said optical signal.

10. The control method according to claim 8, wherein
said instruction includes a first instruction for instructing reduction of power consumption.

11. The control method according to claim 10, wherein
a set value determined according to said first instruction includes a value determined so that a problem does not occur in transmission of said transmission data in a network, said optical communication device being connected to said network.

12. The control method according to claim 8, further comprising a step of:
detecting data received from said network, said optical communication device being connected to said network, wherein
power consumption of at least one of said modulating and said outputting said optical signal is controlled based on said detected data.

13. The control method according to claim 11, further comprising a step of:
storing said set value determined based on said detected data.

14. The control method according to claim 12, wherein
when the power consumption of at least one of said modulating and said outputting said optical signal can be reduced, said set value is determined based on said detected data so that the power consumption of at least one of said modulating and said outputting said optical signal is reduced.

15. A transmission apparatus for outputting an optical signal to a network based on transmission data transmitted from a host apparatus, comprising:
an instruction unit that transmits an instruction; and
an optical communication device, including:
a light source that outputs an optical signal;
a modulation unit that modulates the transmission data and inputs the modulated transmission data to said light source;
a storage unit that holds a set value of said light source or said modulation unit;
a power consumption adjustment unit that, according to said instruction transmitted from said instruction unit, acquires said set value from said storage unit, optimizes power consumption within a predetermined range of transmission characteristics, and determines a set value; and
a control unit, being provided said set value determined by said power consumption adjustment unit, that controls power consumption of at least one of said light source and said modulation unit based on said provided set value.

16. A recording medium storing a program causing a computer to execute control processing for controlling power consumption of an optical communication device outputting an optical signal based on transmission data, said processing comprising:
a step of optimizing power consumption, according to an instruction, within a predetermined range of transmission characteristics and determining a set value of at least one of modulating said transmission data and outputting said optical signal;
a step of modulating said transmission data according to said set value; and
a step of outputting said optical signal according to said set value.

17. An optical communication device, comprising:
a light source for outputting an optical signal;
modulation means for modulating transmission data and inputting said modulated transmission data to said light source;
storage means for holding a set value of said light source or said modulation means;
power consumption adjustment means for, according to an instruction, acquiring said set value from said storage means, optimizing power consumption within a predetermined range of transmission characteristics, and determining a set value; and
control means, being provided said set value determined by said power consumption adjustment means, for controlling power consumption of at least one of said light source and said modulation means based on said provided set value.

18. The optical communication device according to claim 17, wherein
said predetermined range of transmission characteristics is determined by at least one of a transmission rate, an error rate, a strength, a wavelength and a transmission loss of said optical signal.

19. The optical communication device according to claim 17, wherein
said instruction includes a first instruction for instructing reduction of power consumption.

20. The optical communication device according to claim 19, wherein
a set value determined according to said first instruction includes a value determined so that a problem does not occur in transmission of said transmission data in a network, said light source being connected to said network.

21. The optical communication device according to claim 17, further comprising:
detection means for detecting data received from said network, said light source being connected to said network, wherein
said control means controls the power consumption of at least one of said light source and said modulation means based on said detected data.

22. The optical communication device according to claim 21, wherein
said control means stores said set value determined based on said detected data in said storage means.

23. The optical communication device according to claim 21, wherein,
when the power consumption of at least one of said light source and said modulation means can be reduced, said control means determines said set value based on said detected data so that the power consumption of at least one of said light source and said modulation means is reduced.
